(19) United States
(12) Patent Application Publication
(10) Pub. No.: US 2005/0284479 A1
(43) Pub. Date: Dec. 29, 2005

(54) Breathing mask with an adhesive seal

(75) Inventors: Cornelia Schrader, Lubeck (DE); Jorg-Uwe Meyer, Ratzeburg (DE); Gotz Kullik, Lubeck (DE); Hans-Ullrich Hansmann, Barnitz (DE)

Correspondence Address: MCGLEW & TUTTLE, PC, P.O. BOX 9227, SCARBOROUGH STATION, SCARBOROUGH, NY, 10510-9227, US

(73) Assignee: Dragerwerk Aktiengesellschaft, Lubeck (DE)

(21) Appl. No.: 11/082,428

(22) Filed: Mar. 17, 2005

(30) Foreign Application Priority Data
Jun. 23, 2004 (JP) 10 2004 030 069.0

(51) Int. Cl. A62B 18/02; A62B 18/08

(52) U.S. Cl. 128/205.25; 128/206.24

(57) ABSTRACT

A breathing mask with a mask body (3), has a seal (1) at its edge. The seal is placed in contact with the user's face. At least part of the surface of the seal that is in contact with the user's face has an adhesive surface.

### CROSS REFERENCE TO RELATED APPLICATIONS

This application claims the benefit of priority under 35 U.S.C. § 119 of DE 10 2004 030 069.0 filed Jun. 23, 2004, the entire contents of which are incorporated herein by reference.

### FIELD OF THE INVENTION

The present invention pertains to a breathing mask with an adhesive seal, which brings about a sealing action at the time when it is pressed onto the face with a weak pressure.

### BACKGROUND OF THE INVENTION

Masks sealing in such a way may be used wherever the airways are to be protected from the undesired effect of various substances, which may be inhaled with the breathing air, or where breathing gases, to which medically indicated components are optionally added, are to be specifically introduced. This may be exemplified by breathing masks that are delivered with respirators in the broadest sense of the word.

These include, among other things, devices for patients who require respiratory support for various reasons, e.g., sleep apnea or COPD (chronic obstructive pulmonary disease). Such disorders of spontaneous breathing are frequently treated with CPAP respirators or similar devices. CPAP stands for continuous positive airway pressure.

A settable overpressure is made available here for the patient for supporting the respiration. The supply is frequently ensured with constant pressure over the entire breathing cycle via a breathing mask. An overpressure prevails in the breathing mask in relation to the environment, which is set between a few mbar and up to 50 mbar depending on the therapy. To maintain this overpressure in the interior of the mask, the mask is usually sealed with a seal between the mask body and the user's face.

An expiration valve partially ensures that the expired air can escape into the environment when a sufficient pressure increase is generated in the interior of the mask by the expiration. At the same time, it ensures the scavenging of the mask with fresh breathing gases due to a continuously flowing volume flow.

A leak rate of a few L per minute can be tolerated during such applications, in which fresh gas scavenging takes place in the interior of the mask. By contrast, maximum sealing action is desirable for other critical applications.

The sealing action is achieved, especially in so-called half masks, by the mask body being limited circumferentially by a seal, which is pressed against the face of the user by pressing on the mask and thus ensures the desired sealing. The wearing comfort of such masks is determined essentially by the manner in which the force applied to press on the mask is transmitted as a pressing pressure via the seal onto the face in the area of the contact line between the mask and the face. The interior of the mask is sealed against the environment along this contact line. Each area of the contact line must be pressed sufficiently firmly against the user's face especially in case of applications that operate with an overpressure in the interior of the mask in order to counteract the tendency of the mask lifting off. However, due to their nature, conventional mask bodies are only conditionally suitable for uniform transmission of forces to irregularly shaped and changing surfaces over the contour of their own edge, a pressing force that may lead to needlessly high pressing pressures at some points of the face must usually be preset in order to guarantee the desired sealing action. A reduction of these strong pressing forces by generally reducing the pressing force, which would be able to be set, for example, by means of the strap of the mask, would be very likely to lead to leakages in other areas of the contact line as a consequence.

The seal on the contact line is frequently designed as a silicone lip or silicone tube embodying the function of a sealing strip. Besides the separation of the gases proper, the mask body, which can be adapted only conditionally, can be adapted, to a limited extent, to the contours of the face due to the elasticity of this sealing lip. A different deflection or deformation of the seal is necessary for this. Nevertheless, the problem that continues to be present is that zones with greatly different pressing pressures are formed if differences develop in the distance between the mask body and the contours of the face along the contact line. Each area with excessively low pressing pressure may lead to leakage. Any pressing pressure that is excessively low leads to a needless load for the corresponding zones of the face and may generate pressure points in these zones. The loss of wearing comfort associated herewith may, moreover, lead to acceptance problems during the use of the above-described masks.

Processes that are to bring about the highest possible flexibility of the sealing strip are known. These processes utilize the internal pressure of the interior space of the mask to support the pressing force by generating a degressive spring characteristic. Attempts are made to keep the pressing pressure constant and not to make it dependent on the deflection of the sealing lip, similarly to a spring characteristic. However, this goal is reached only partially and is not applicable to all contact line geometries.

Thus, the problem that continues to be present is that the mask must be pressed onto the face with a markedly stronger force than would be necessary to compensate the force that could enable the mask to be lifted off as a function of the internal pressure in the mask and the area on which this internal pressure acts. The pressing force is usually built up by a tension of the straps and is transmitted to the mask body.

The higher the intended internal pressure and the more uniform the pressing pressure of the mask body on the face, the stronger must be the force with which the mask must be pressed on. If the internal pressure largely compensates the pressing pressure, the contact of the mask is not usually felt by the user to be unpleasant. However, sufficient sealing action cannot be expected in this state for the above-mentioned reasons in case of conventional masks.

If, by contrast, the pressing force is markedly higher, the mask is frequently felt to be unpleasant, especially when an excessively nonuniform distribution of the pressing pressure leads to pressure peaks in individual areas of the seal.

### SUMMARY OF THE INVENTION

The basic object of the present invention is to propose a breathing mask that is improved compared to the state of the art and that is characterized by a greater wearing comfort and prevents the development of peaks of the pressing pressure on the user's face, which are felt to be unpleasant.

The present invention is based on the fact that it is possible to utilize other forces for achieving the firm seating and the necessary sealing action of the mask, besides the forces applied by holding devices arranged on the mask, which latter forces ensure that the mask is permanently pressed on the face. The utilization of the adhesive properties of the seals, which are in direct contact with the user's face, is considered for this purpose according to the present invention. The use of seals with adhesive properties leads to the supporting or even replacement of the tensile force, which would otherwise have to be applied by the straps alone or by other holding devices of the breathing mask.

Thus, the present invention comprises a breathing mask with a mask body, which has a seal at its edge, which said seal is in contact with the user's face, and at least part of the surface of the seal that is in contact with the user's face has an adhesive surface.

In one embodiment, the seal is soft and flexible and has at least partially an adhesive coating on the surface facing the surface of the face.

The adhesive surface forms a bonding surface. The maximum available adhesive strength can be set by selecting the adhesive properties and the size of the contact area. The actions of compressive and tensile forces are reversed in the contact area between the face and the mask in many applications, which is usually felt to be pleasant and prevents pressure points from developing. Good sealing action can nevertheless be achieved.

It is especially advantageous if the breathing mask additionally comprises a holding device. This may comprise straps, which are known per se. The high safety of fixation of the mask by a conventional fastening with a pleasantly low pressing pressure can thus be combined with a wearing comfort that results from the manner of fastening according to the present invention. The tensile forces originating from the straps can be set such that the pressing pressure is nearly completely neutralized by the interior pressure of the mask.

In an advantageous embodiment of the present invention, the adhesive coating contains an adhesive, which is similar to a pressure-sensitive adhesive gel, as it is used to fasten electrodes. It is advantageous in this connection if the bonded surface can be frequently removed and refastened without a change in its properties. Cleaning with water is also possible.

In advantageous embodiments, the adhesive surface, which is in contact with the user's facial skin, has an adhesive strength of at least 0.4 N/cm².

It is especially advantageous if the mask body can be adapted to the shape of the face, plastic adaptability offering special advantages. It is achieved due to the adhesive coating or adhesive surface that no additional pressing force is needed for the seal during the operation. The seal is kept in place on the surface of the face by the adhesive force and, namely, in the shape and with the contact surface with which the user has pressed on the mask when he put it on.

It is advantageous if the adaptation to the shape of the face can be performed by a moldable frame arranged in the vicinity of the edge of the mask body. The frame stabilizes the shape of the edge of the mask body. It assumes the shape stabilization function according to the contours of the user's face and is used to absorb the forces that are due to the internal pressure, the fastening on the head and optionally the mounting of the inspiration and expiration connections. This frame is sufficiently dimensionally stable, robust and hygienically satisfactory in use. Nevertheless, it makes possible a plastic deformation of the frame and hence of the mask body for adaptation to the face of the breathing mask user by strong pressing onto the face or the action of another force. The adhesive seal is fastened to this frame or in its vicinity at the edge of the mask body and is loaded especially uniformly due to the frame being adapted to the contours of the face.

Since considerable removing forces may become necessary in case of large bonding surfaces to remove a mask fastened according to the present invention from the face, it is advantageous if means for facilitating the removal of the mask body are provided. These may comprise, for example, means for changing the cross section of the seal adhering to the face. In other advantageous embodiments, they comprise means for setting the temperature of the bonding surface. If a material whose adhesive strength depends on the temperature is used for the adhesive coating, the removal of the mask can be facilitated by changing the temperature in a specific manner. Other possibilities of supporting the removal of the mask by other thermal, chemical or physical effects may also be included when designing the adhesive surfaces.

In another embodiment of the breathing mask according to the present invention, it can be guaranteed by a specially adapted shaping of the bonding surface that the bonding surface will be removed only in pieces or gradually during the removal of the mask. Excessively strong forces are thus prevented from being needed for the removal as a result. The removal process takes place similarly to that of a weakly adhering patch.

The mask may also comprise a flexible mask body, which is deformed during the removal process. Peeling off of the bonding surface can be brought about by the deformation. As a result, substantially weaker forces are needed during the removal than when the complete surface is pulled off or when the bonding surface is shorn off

The present invention will be explained in greater detail on the basis of exemplary embodiments shown in the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic side view of a nasal CPAP mask;

FIG. 2 is a schematic front view of a nasal CPAP mask;

FIG. 3 is a schematic side view of a nasal CPAP mask with a specially designed sealing lip;

FIG. 4 is a partially cutaway sectional view of a specially designed seal with settable surface temperature; and

FIG. 5 is a partially cutaway sectional view of a specially designed seal with settable cross section.

### DESCRIPTION OF THE PREFERRED EMBODIMENTS

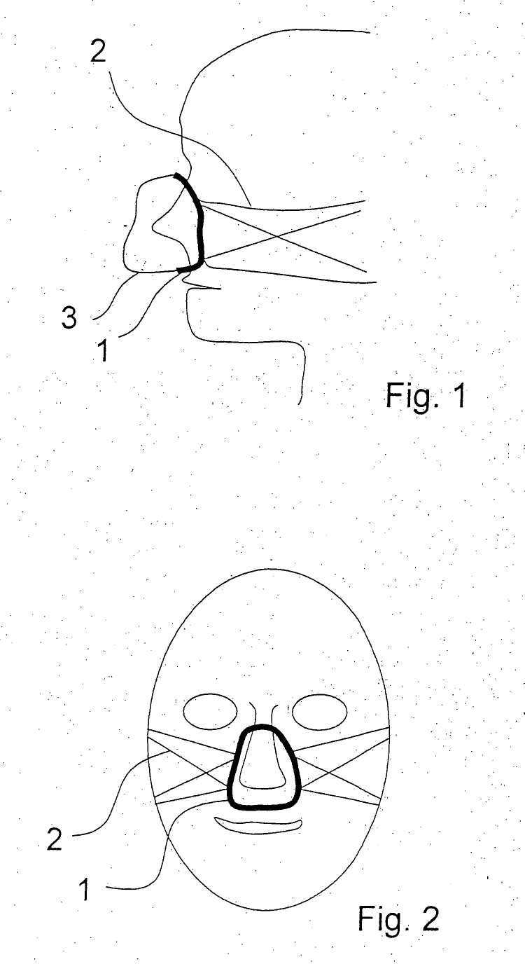

Referring to the drawings in particular, in exemplary embodiment 1, FIGS. 1 and 2 show two views of a nasal CPAP mask. The mask is equipped with an adhesively acting seal 1, designed here as a silicone lip coated with an adhesive gel. A strap 2 acting as a holding device for fixing the mask on the head is likewise present and transmits part of the needed tensile force to counteract the overpressure in the interior space of the mask body 3.

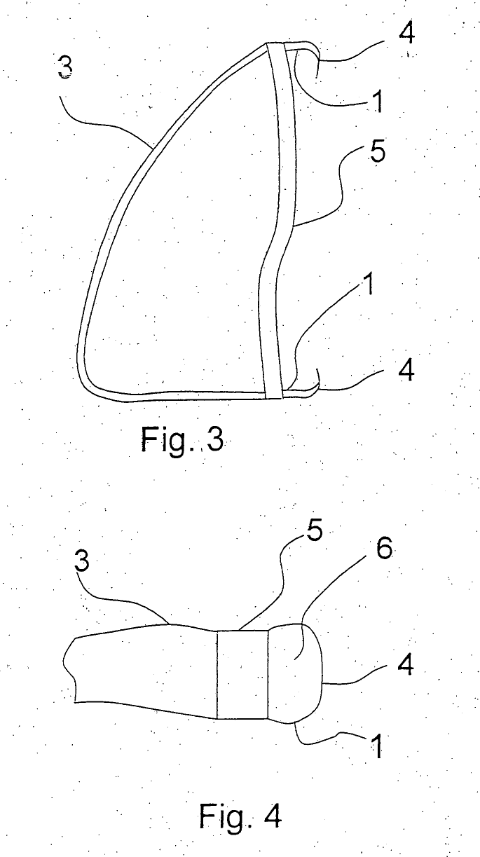

FIG. 3 shows a similar mask, whose mask body is equipped with a circumferential silicone lip 1, part of which can be folded over such that it acts as a bonding surface 4. The silicone lip 1 is fastened to a moldable frame 5, by which adaptation to the shape of the face can be performed. The frame 5 forms at the same time the closure of the mask body 3.

In exemplary embodiment 2, FIG. 4 shows a breathing mask according to the present invention with a specially designed seal to facilitate the removal of the mask from the face. It includes a possibility of thermally affecting the adhesive force in order to make removal possible at reduced adhesive force. The seal 1 is designed as a flexible tube for this purpose. The outer side of this flexible tube is designed as a bonding surface 4 and is wetted with an adhesive gel, which develops a weak adhesive force below a temperature of 25° C. If this seal is pressed onto the face, sufficient adhesive force will develop in a short time due to the rising temperature. To remove the mask, cool water is sent through the interior 6 of the flexible tube. If the temperature of the bonding surface drops below 25° C. as a result, the mask can be removed from the face in a simple manner because of the reduced adhesive force. The cooling can be brought about by flushing with cool water within the flexible tube 6 by means of a syringe.

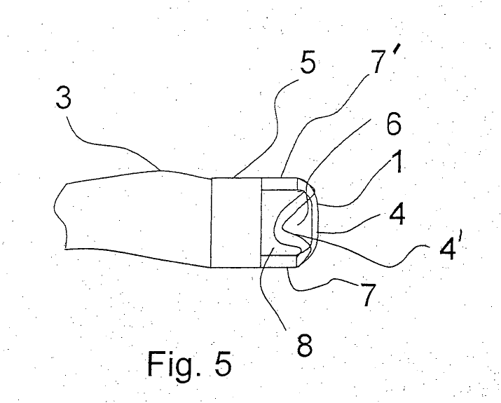

In exemplary embodiment 3, FIG. 5 shows a breathing mask according to the present invention with a specially designed seal to facilitate the removal of the mask from the face. It includes a possibility of changing the cross section of the seal 1. The seal 1 is designed as a flexible surface between two webs 7, 7′ for this purpose. If a pressure is admitted into the cavity 8 formed or the volume is sealed, the bonding surface 4, which is coated with an adhesive gel, can be placed on the face for bonding. To remove the mask, the cavity 8 can be evacuated by means of a syringe or a bellows, as a result of which the adhering surface seeks to assume a position 4′ that facilitates the removal of the mask from the skin surface.

While specific embodiments of the invention have been shown and described in detail to illustrate the application of the principles of the invention, it will be understood that the invention may be embodied otherwise without departing from such principles.

1. A breathing mask, comprising:
a mask body;
a seal at an edge of said mask body, said seal being in contact with the user's face during use, at least part of a surface of the seal that is in contact with the user's face having an adhesive coating consisting of an electrode bonding gel to form an adhesive surface.

2-3. (canceled)

4. A breathing mask in accordance with claim 1, wherein the adhesive surface in contact with the user's facial skin has an adhesive strength of at least 0.4 N/cm².

5. A breathing mask in accordance with claim 4, further comprising a holding device wherein said mask body is a nasal mask body with a frame for fully enclosing a nose of a user and said seal in contact with the user's face extends fully around the nose of the user during use and the mask is a continuous positive airway pressure nasal mask.

6. A breathing mask in accordance with claim 1, wherein:
said mask body is a nasal mask body with a frame for fully enclosing a nose of a user and said seal in contact with the user's face extends fully around the nose of the user during use; and
said mask body is formed of material that can be adapted to the shape of the face in a region adjacent to and about the nose of the user.

7. A breathing mask in accordance with claim 6, wherein the adaptation to the shape of the face can be performed by said frame being a moldable frame arranged in the vicinity of the edge of said mask body.

8. A breathing mask in accordance with claim 1, further comprising means for facilitating the removal of the mask body including disengaging the adhesive from the skin of the user.

9. A breathing mask in accordance with claim 8, wherein said means for facilitating the removal of the mask body comprise means for changing the cross section of the seal adhering to the face.

10. A breathing mask in accordance with claim 8, wherein said means for facilitating the removal of said mask body comprise an adhesive, whose adhesive action can be set by varying a temperature of said adhesive.

11. A breathing mask, comprising:
a nasal mask body with a nose frame for fully enclosing a nose of a user;
a nose periphery seal at an edge of said mask body, said seal having a user contact surface in contact with the user's face extending fully around the nose of the user in a region directly adjacent to the nose of the user during use, said contact surface having adhesive qualities for adhering said contact surface to the user's face during use.

12. A breathing mask in accordance with claim 1, wherein said contact surface having adhesive qualities comprises an adhesive coating on said contact surface.

13. A breathing mask in accordance with claim 12, wherein the adhesive coating comprises an electrode bonding gel.

14. A breathing mask in accordance with claim 12, wherein the adhesive coating has an adhesive strength of at least 0.4 N/cm² and the mask is provided as a continuous positive airway pressure nasal mask.

15. A breathing mask in accordance with claim 11, further comprising a holding strap, wherein said seal in contact with the user's face extends fully around the nose of the user during use with holding pressure applied by said holding strap.

16. A breathing mask in accordance with claim 5, wherein said frame is a moldable frame defining an edge of said mask body.

17. A breathing mask in accordance with claim 2, further comprising a removal means for facilitating removal of said adhesive coating on said contact surface from the user's face.

18. A breathing mask in accordance with claim 17, wherein said removal means comprises means for changing the cross section of the seal adhering to the face.

19. A breathing mask in accordance with claim 17, wherein said means for facilitating the removal of said mask body comprise an adhesive, whose adhesive action can be set by varying a temperature of said adhesive, whereby heat is applied or removed to release the mask from the face of the user.

20. A method of using a breathing mask, comprising:
providing a mask body with a frame for fully enclosing a nose of a user and a seal at an edge of the frame of the mask body the seal having a user face contact surface of a size to extend fully around a nose of a user and contact a face of the user around the nose;
providing at least part of the contact surface with an adhesive surface;
engaging the contact surface with the face of the user fully around the nose of the user to enclose the nose in the mask frame, such that at least some of the adhesive surface of the seal is in contact with the user's face; and
operating the mask as a continuous positive airway pressure nasal mask.

21. A method in accordance with claim 20, wherein the contact surface has adhesive qualities comprising an adhesive coating on the contact surface, wherein the adhesive coating comprises an electrode bonding gel.

22. A method in accordance with claim 21, wherein the adhesive coating has an adhesive strength of at least 0.4 N/cm².
